(19) United States
(12) Patent Application Publication
(10) Pub. No.: US 2011/0180517 A1
(43) Pub. Date: Jul. 28, 2011

(54) METHODS AND SYSTEMS FOR BINDING A WIRELESS CONTROL DEVICE TO A WELDING POWER SOURCE

(75) Inventor: Joseph C. Schneider, Menasha, WI (US)

(73) Assignee: Illinois Tool Works Inc., Glenview, IL (US)

(21) Appl. No.: 12/953,329

(22) Filed: Nov. 23, 2010

Related U.S. Application Data
(60) Provisional application No. 61/298,341, filed on Jan. 26, 2010.

(51) Int. Cl. B23K 11/24

(52) U.S. Cl. 219/108

(57) ABSTRACT

A welding system including a welding power source, a receiver, and a wireless control device are provided. The receiver is adapted to communicate information to and from the welding power source. The wireless control device and/or the receiver is adapted to learn a first address specific to the receiver and the wireless control device pair to exclusively bind the welding power source to the wireless control device during a learning mode. Such a binding may occur when the wireless control device is located a distance from the welding power source that is below a preset threshold. The wireless control device controls operation of the welding power source when the wireless control device is bound to the welding power source.

### CROSS REFERENCE TO RELATED APPLICATIONS

This application is a Non-Provisional Patent Application of U.S. Provisional Patent Application No. 61/298,341 entitled “Method for Programming a Wireless Welding System”, filed Jan. 26, 2010, which is herein incorporated by reference.

### BACKGROUND

The invention relates generally to welding systems and, more particularly, to the binding of wireless controls to welding power supplies.

Welding is a process that has become ubiquitous in various industries for a variety of types of applications. For example, welding is often performed in applications such as shipbuilding, aircraft repair, construction, and so forth. During such welding processes, a variety of control devices are often provided to enable an operator to control one or more parameters of the welding operation. For example, foot and hand activated controls may be provided such that the operator may alter the amperage, voltage, or any other desirable parameter of the welding process. Traditionally, such controls include wired connections through which the control communicates the desired welding parameters to the welding power source. As such, the wired controls may be located remote from the welding power source, thus allowing an operator to alter weld parameters from the weld location.

Unfortunately, the welding environment is often cluttered with many cords, and the wired connection between the control device and the power source may introduce additional undesirable clutter and may limit the reach of the control device. Accordingly, wireless control devices have been developed that eliminate the use of a wired connection between the control device and the welding power source. Unfortunately, since such devices no longer feature a wired connection to the welding power sources, such wireless devices may disadvantageously operate more than one welding power source at the same time, or may operate or be paired with a power supply other than the one the operator anticipates, causing confusion and potential errors in setting the power supply for the desired welding operation. Accordingly, there exists a need for improved wireless devices for control of welding power sources.

### BRIEF DESCRIPTION

In an exemplary embodiment, a welding system includes a welding power source adapted to generate a welding power output for use in a welding operation and a wireless control device adapted to substantially exclusively control operation of the welding power source when the wireless control device is bound to the welding power source. The welding system also includes a receiver integrated with the welding power source and adapted to learn a first address specific to the receiver and the wireless control device pair to exclusively bind the welding power supply to the wireless control device during a learning mode and to clear the first address upon initiation of a second learning mode. The wireless control device is adapted to learn the first address specific to the receiver and the wireless control device pair to exclusively bind the wireless control device to the welding power source during the learning mode and to clear the first address upon initiation of the second learning mode.

In another embodiment, a method includes the steps of determining a unique address specific to a wireless control and welding power source pair and storing the unique address in a memory of the wireless control and in a memory of the welding power source during a learning mode. When the unique address is stored in the memory of the wireless control and the memory of the welding power source, the wireless control is adapted to exclusively control operation of the welding power source. The method further includes the step of clearing the unique address from the memory of the wireless control and the memory of the welding power source when a second learning mode is enabled.

In another embodiment, a welding system includes a welding power source adapted to generate a welding power output for use in a welding operation and a receiver associated with the welding power source and adapted to communicate information to and from the welding power source. The welding system also includes a wireless control device adapted to learn a first address specific to the receiver and the wireless control device pair to exclusively bind the welding power source to the wireless control device during a learning mode when the wireless control device is located a distance from the welding power source that is below a preset threshold. The wireless control device controls operation of the welding power source when the wireless control device is bound to the welding power source.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary welding system including a welding power source with an external receiver and a wireless foot control in accordance with aspects of the present invention;

FIG. 2 is a perspective view of an exemplary welding system including a welding power source with an internal receiver and a wireless foot control in accordance with aspects of the present invention;

FIG. 3 is a flow chart illustrating a lockout binding method that may be employed to enable or disable a receiver to bind with a desired device in accordance with aspects of the present invention;

FIG. 4 is a flow chart illustrating exemplary control logic that may be utilized to control a receiver of the welding power source during a learning mode in accordance with aspects of the present invention; and

FIG. 5 is a flow chart illustrating exemplary control logic that may be utilized to control a wireless control during a learning mode in accordance with aspects of the present invention.

### DETAILED DESCRIPTION

As described in detail below, embodiments of welding systems including a welding power source, a receiver associated with the welding power source, and a wireless control are provided. The wireless control may be bound to any of a variety of welding power sources and, when bound, the wireless control is configured to control operation of one or more parameters of the welding power source. Similarly, the welding power source may be bound to a variety of wireless control devices and, when bound, the welding power source is configured to be controlled by the wireless control device to which it is bound. Further, such a bind between a particular wireless control device and a given welding power source may occur when each device is placed in a learning mode and is located within a given distance threshold. For example, if a wireless control is located beyond a given distance threshold, the welding power source and/or the wireless control device may prevent initiation of the binding process. Still further, once a wireless control device and a welding power source have been bound together during a learning mode, such devices may be configured to exclusively operate with one another and to prevent additional binding with another device unless an additional learning mode is initiated (e.g., when an operator places the device in learning mode by flipping an appropriate switch).

Embodiments of the present invention may include features that substantially reduce or prevent the likelihood of the wireless control device binding with more than one welding power source at the same time. For example, in some embodiments, the wireless control device and the welding power source both learn a unique address specific to that pair of devices. Further, each of the devices is configured to clear the unique address specific to the previous pair when subsequently placed in another learning mode. Subsequent pairings of the wireless control device or the welding power source to a different device would then lead to generation of another unique address. In such a way, each wireless control device is configured to operate only one welding power source at a time.

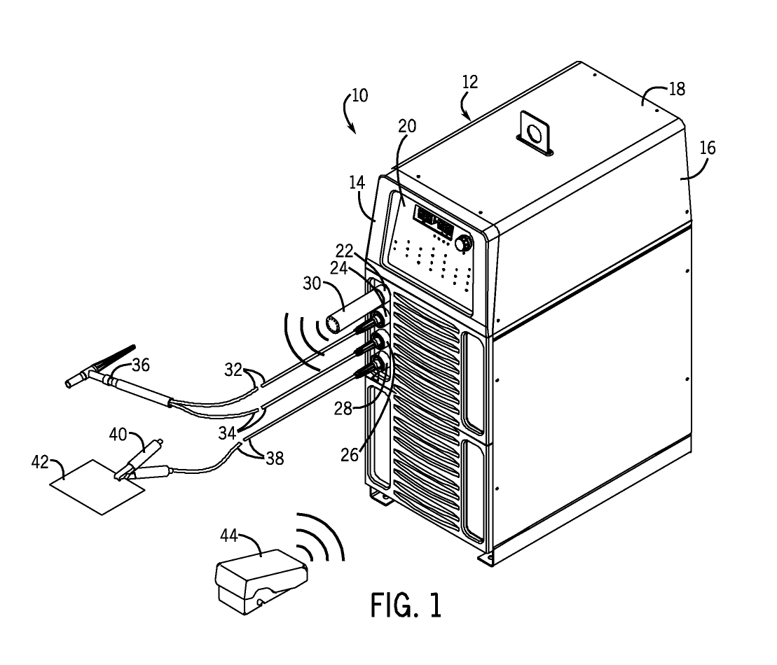

Turning now to the drawings, FIG. 1 is a perspective view of an exemplary welding system 10 including an exemplary welding power source 12 configured to provide a power output for a tungsten inert gas (TIG) welding operation or a stick welding operation. However, it should be noted that in further embodiments, the welding power source may be configured to produce power for any desirable type of welding operation (e.g., metal inert gas (MIG) welding). In the illustrated embodiment, the welding power source 12 includes a front panel 14, a side panel 16, and a top panel 18. The front panel 14 includes a control panel 20 through which an operator may control one or more parameters the welding operation.

The welding power source 12 further includes receptacles 22, 24, 26, and 28 that are configured to receive one or more welding devices and/or accessories. For example, in the illustrated embodiment, the first receptacle 22 receives a wireless receiver 30, the second and third receptacles 24 and 26 receive cables 32 and 34 that connect to a welding torch 36, and the fourth receptacle 28 receives cable 38 that terminates in ground clamp 40. The ground clamp 40 connects to a workpiece 42 to close the circuit between the welding power source 12, the workpiece 42, and the welding torch 36 during operation. The welding system 10 of FIG. 1 also includes a wireless control device, foot pedal 44, which is configured to communicate with the wireless receiver 30 to control one or more parameters of the welding process.

During use, the foot pedal 44 may be wirelessly bound to the welding power source 12 via the receiver 30 and, when bound, the foot pedal 44 controls a parameter of the welding process. For example, when bound, the foot pedal 44 may function as an amperage control that sends a signal to the welding power source 12 via the receiver 30 to increase the weld current as the foot pedal 44 is depressed and to decrease the weld current as the foot pedal 44 is released. To that end, the foot pedal 44 and the welding power source 12 are each configured to be placed in a learning mode, during which binding between the foot pedal 44 and the welding power source 12 may occur. For example, in some embodiments, the user may place the foot pedal 44 in learning mode by depressing a button located on the foot pedal, and the user may additionally place the welding power source 12 in learning mode by depressing a button located on the control panel 20.

Additionally, in some embodiments, any suitable gestures, actions, or series of events may be utilized to place the wireless control device and/or the receiver of the welding power source in learning mode. In such a way, a learning mode may be triggered via a sequence of events or triggers. For example, in one embodiment in which the wireless control is a foot pedal, the foot pedal may be depressed from a full upward position to a complete bottom position within a given time period to place the foot pedal in a learning mode. Such a feature may have the advantage of reducing or eliminating the possibility that another control device located in the same local vicinity may be accidentally bound to an undesired device.

When the foot pedal 44 and the welding power source 12 are both in learning mode, such devices are configured to reversibly bind to one another. For example, as described in more detail below, in learning mode, the foot pedal 44 and the receiver 30 may recognize each other's presence within a predefined vicinity, and a unique address associated with the foot control 44 and welding power source 12 pair is then stored in both the foot pedal 44 and the welding power source 12. That is, both the welding power source and the wireless control (e.g., the foot pedal 44) store the unique address during a learning mode and, when subsequently placed in operational mode, the foot pedal 44 is configured to solely operate the welding power source to which it is bound. Similarly, the welding power source is configured to be exclusively operated by the foot pedal 44 control to which it is bound. Such an exclusive operational connection remains until the foot pedal 44 and/or the welding power source 12 is again placed in learning mode, when either device may then rebind with another device. The foregoing feature of the present invention may offer distinct advantages over traditional systems in which only the welding power source learns a preset address of the foot pedal. For example, in these traditional systems, multiple welding power sources may learn the same foot pedal address and, accordingly, the same foot pedal may be operational with a number of welding power sources at the same time. Embodiments of the present invention, however, provide for a wireless control to operate only one welding power source at a time. Such features are described in more detail below.

In the embodiment of FIG. 1, the receiver 30 associated with the welding power source 12 is connected to receptacle 22 located on the exterior of the welding power source 12. As such, the receiver 30 and the foot pedal 44 in the embodiment of FIG. 1 may be configured as a retrofit kit for existing power sources. That is, since the receiver 30 is configured to be received by an existing connection on the welding power source, the receiver 30 may be plugged into any suitable welding power supply and, accordingly, any suitable welding power supply may be bound to the foot control 44 via the external receiver 30.

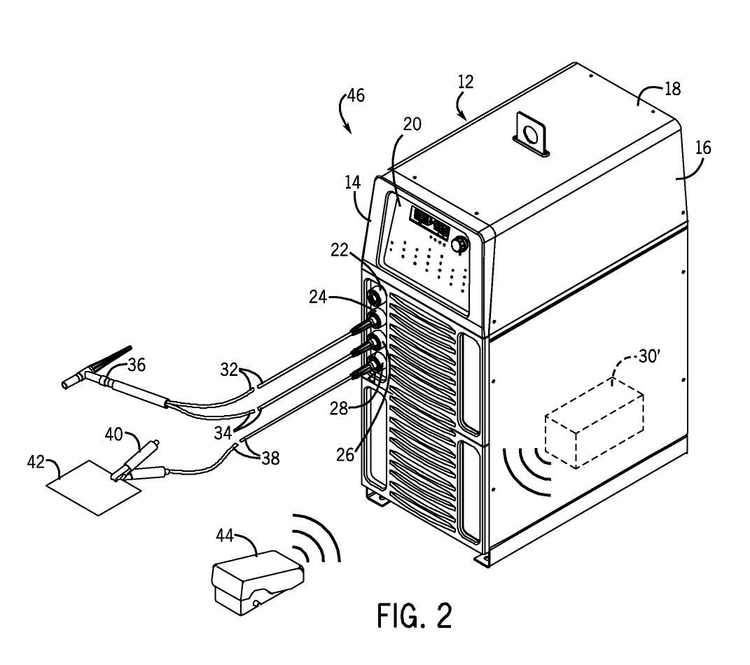

Alternatively, in another embodiment, as shown in FIG. 2, a welding system 46 may include a welding power source 12 with an internal receiver 30′ that is integral with the electronics of the welding power source 12. As such, in this embodiment, the welding power source 12 is internally configured to communicate with one or more external wireless control devices. As before, the receiver 30′ and the foot control 44 are configured to reversibly bind during a learning mode to exclusively operate as a pair during a subsequent operational mode. Further, the foot pedal 44 and the internal receiver 30′ are each configured to learn a unique address specific to the receiver 30′ and the foot control 44 pair. As such, each time the foot control 44 binds with another welding power source during a learning mode, an address specific to that particular power source and foot control pair is generated. Again, once the unique address is learned by the wireless control and the welding power source, each device is configured to exclusively operate with the other device.

In certain embodiments, it may be desirable to limit the area in which the wireless control is located in order for binding with the welding power supply to occur. That is, in some embodiments, the welding power source may be configured to bind with a wireless control when in learning mode only if the wireless control is located within a predefined distance (e.g., within an approximately 20 foot radius) from the welding power source. Such a feature of embodiments of the present invention may substantially reduce or prevent the likelihood of a welding power source binding with a foot pedal located outside of the immediate welding environment (e.g., not located within sight or hearing distance of a welding operator in close proximity to the welding power source).

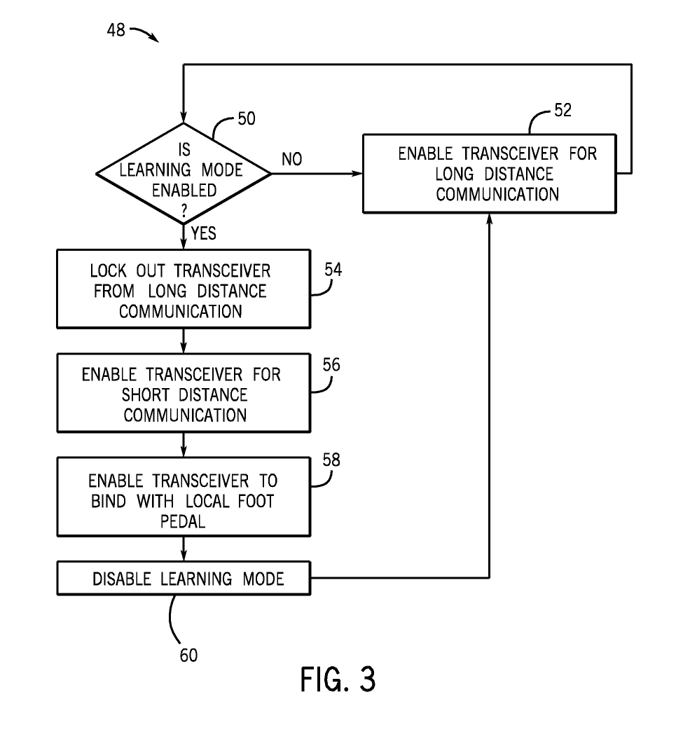

FIG. 3 is a flow chart illustrating an exemplary method 48 that may be employed in embodiments in which the welding power source is substantially restricted from binding with a wireless control located outside a predefined local vicinity of the welding power source. Such a method 48 may be utilized by a transceiver located within, for example, the receiver of FIG. 1 or FIG. 2 associated with a welding power source. In the illustrated embodiment, the method shown applies to a welding power source binding with a foot pedal. However, it should be noted that embodiments of the described method may be applicable to the binding of a welding power source with any suitable wireless control device (e.g., foot control, hand activated control, etc.).

The method 48 includes the step of checking whether a learning mode is enabled (block 50). A learning mode may be enabled, for example, by depressing a button or switching a switch located on a control panel of the welding power source. If the learning mode is not enabled, the transceiver is enabled for long distance communication (block 52). If the learning mode is enabled, the transceiver is locked out from long distance communication (block 54) but is enabled for short distance communication (block 56). Again, such a feature may limit the area in which a wireless control must be located in order to bind with the welding power source and, accordingly, may reduce or prevent the likelihood of the welding power source undesirably binding with a wireless control located a long distance away from the desired welding environment. The method 48 further includes the step of enabling the transceiver to bind with a local foot pedal (block 58). After the transceiver has bound the welding power source to the local foot pedal, the learning mode is disabled (block 60), and the transceiver is once again enabled for long distance communication (block 52). In this way, the transceiver may be limited to communicate within a predefined distance range of the welding power supply during the learning mode, but may be enabled for more far reaching communication during operational mode.

Although in the embodiment of FIG. 3, the area in which the wireless control device is located in order for binding with the receiver of the welding power supply to occur is restricted, in some embodiments, such an area may not be restricted. However, certain embodiments may still include alternate features that substantially reduce or prevent the likelihood of an undesired wireless control and receiver pairing. For example, in one embodiment, each of the wireless control device and the receiver may be placed in a respective learning mode, and, once placed in learning mode, each of the devices may be enabled to bind with another device regardless of the distance between the two devices. That is, in some embodiments, the receiver and the wireless control device may be enabled for long distance binding only when each device is enabled for learning. In such a way, the wireless control device and the receiver may be configured not to bind with devices that are not placed in learning mode.

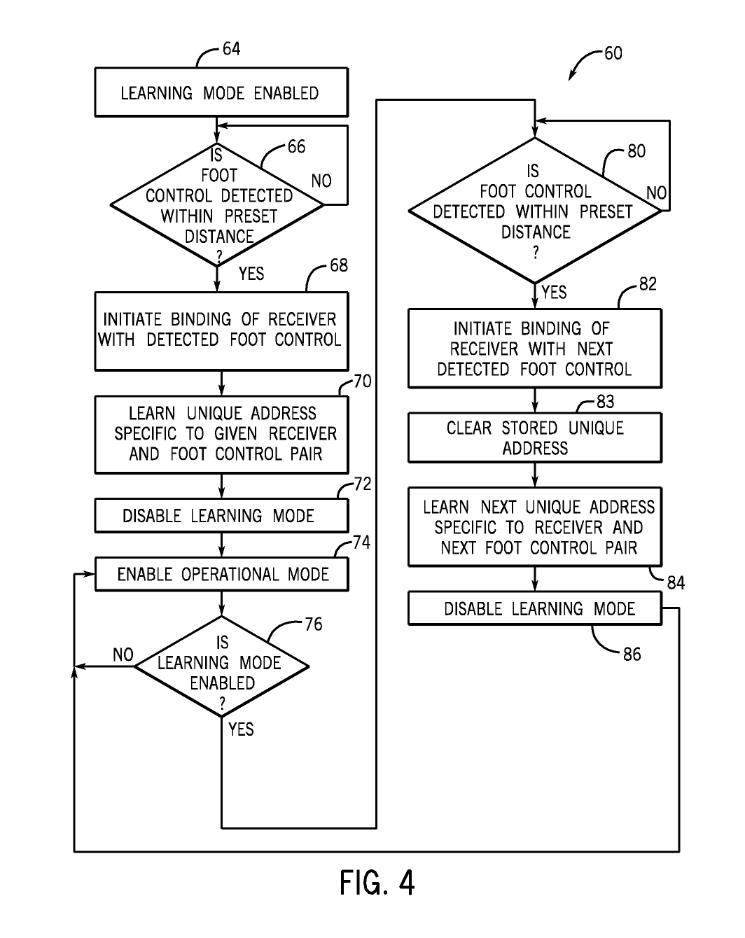

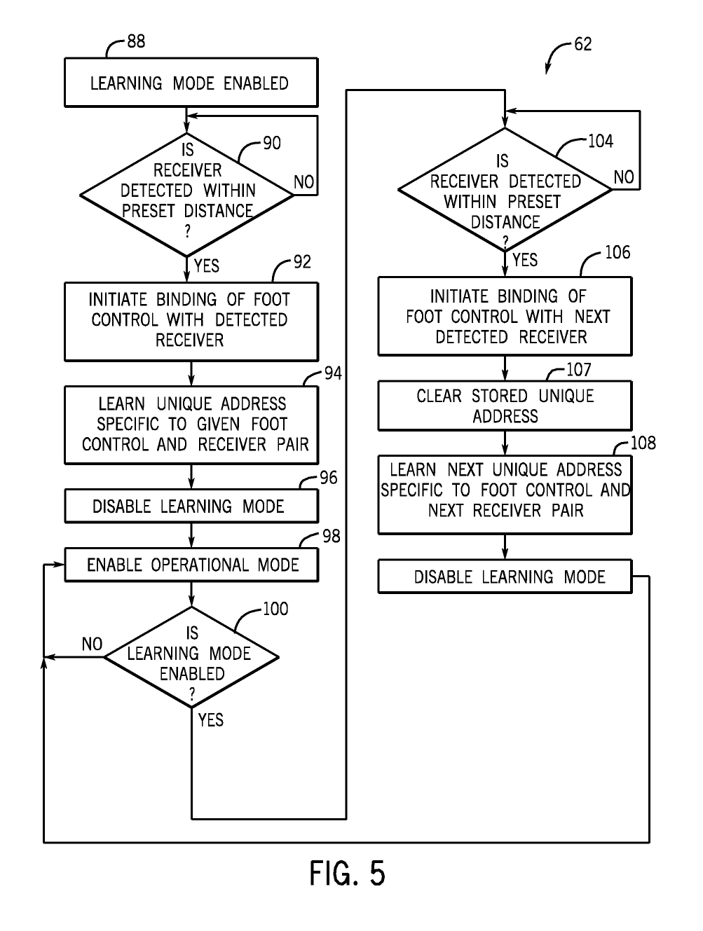

FIG. 4 illustrates an exemplary method 60 that may be implemented, for example, by a controller located within a welding power source, to bind the welding power source to a wireless control. Similarly, FIG. 5 illustrates an exemplary method 62 that may be implemented, for example, by a foot pedal controller, to bind the foot pedal to the welding power source. Again, although the embodiments of FIGS. 4 and 5 are illustrated in the context of a wireless foot control, it should be noted that such methods may apply to any suitable wireless control and are not limited to a foot activated pedal.

Turning now to the illustrated methods, the method 60 begins when a learning mode is enabled (block 64), for example, via user input to a control panel. The method 60 further includes the step of inquiring as to whether a foot control is detected within a preset distance from the welding power source (block 66). If a foot control is not detected, the controller continues to check for the presence of a suitable foot control. If a foot control is detected, binding of the receiver with the detected foot control is initiated (block 68) and a unique address specific to the given receiver and foot control pair is learned (block 70). That is, an address that is associated only with the bound pair of devices is generated and stored in the welding power source. After storing of the unique address and, thus, binding of the receiver and the foot control, learning mode is disabled (block 72) and operational mode is enabled (block 74). During the operational mode, since the receiver and the foot control are bound, the welding power source is configured to be operated only by the foot control to which it is bound.

During operational mode, the method further includes checking whether learning mode has been re-enabled (block 76). If learning mode has been enabled, the welding power source again checks for the presence of a foot control within a preset distance (block 80). As before, if a foot control is not detected, the welding power source continues to monitor for a suitable foot control presence. However, if a second foot control is detected, the controller of the welding power source initiates binding of the receiver with the second detected foot control (block 82). In the illustrated embodiment, the stored unique address specific to the welding power source and the foot control to which it was bound is cleared from memory (block 83). Therefore, in certain embodiments, once learning mode is subsequently re-enabled and binding has been initiated with an additional foot control, the welding power source is no longer bound to the first foot control. A second address specific to the welding power source and the second foot control pair is then determined and stored to memory (block 84). Subsequently, learning mode is again disabled (block 86), and the welding power source is then bound to and controlled by the second foot control.

It should be noted that although in the illustrated embodiment, the stored unique address is cleared from memory after binding has been initiated with the next detected foot control, the clearing of the previously stored address may occur after binding has been initiated with the next foot control, when the next unique address is learned, or after the next unique address is learned. For example, in one embodiment, the previously learned address may be cleared from memory concurrently with the storing of the next address to memory. Indeed, the previously stored address may be cleared from memory at any suitable point during the second learning mode.

As shown, the welding power supply may be placed in learning mode and bound with alternate wireless control devices as desired by the operator. However, each time the welding power source is bound to a new wireless control device, a new address unique to that particular pair of devices is learned and any previous addresses are cleared from memory. As mentioned above, such a feature of certain embodiments may prevent or eliminate the possibility of a welding power source being disadvantageously bound to multiple wireless control devices.

Similarly, the method 62 begins when a learning mode is enabled (block 88) and an inquiry is made as to whether a receiver is detected within a preset distance from the foot control (block 90). If a receiver associated with a welding power source is not detected, the controller continues to check for the presence of a suitable receiver. However, if a suitable receiver is detected, binding of the foot control with the detected receiver is initiated (block 92) and a unique address specific to the given foot control and receiver pair is learned (block 94). After storing of the unique address and, thus, binding of the foot control to the detected receiver, learning mode is disabled (block 96), and operational mode is enabled (block 98). During the operational mode, the foot control is configured to exclusively operate the welding power source to which it is bound.

During operational mode, the method further includes checking whether learning mode has been re-enabled (block 100), and, if so, the foot control again checks for the presence of a receiver within a preset distance (block 104). As before, if a receiver is not detected, the foot control continues to monitor for a suitable receiver. However, if a second receiver is detected, the foot control initiates binding of the foot control with the second detected receiver (block 106). The previously stored unique address is cleared from memory (block 107), and a second address specific to the foot control and the second receiver pair is then determined and stored to memory (block 108). Again, it should be noted that clearing of the previously stored address may occur at any suitable point during the re-enabled learning mode, such as after binding has been initiated with the next receiver, when the next unique address is learned, or after the next unique address is learned. Subsequently, learning mode is again disabled (block 110), and the foot control is then bound to and able to control the welding power source associated with the second receiver. Again, each time the foot control is placed in learning mode, the foot control may be bound to a new welding power source via the receiver. However, each time the foot control is bound to a new receiver, a new address unique to that pair of devices is generated.

In the illustrated embodiments, the wireless control and the receiver are configured to initiate binding with a suitable device and to determine and store the unique addresses. However, such a feature is merely exemplary, and in other embodiments, either the wireless control or the receiver may be configured to solely initiate binding and generate the unique address specific to the pair of devices. Nevertheless, however, each time a pair of devices is binding, a unique address is stored in both devices. Again, such a feature may reduce or prevent the likelihood of a wireless control device operating more than one welding power source at the same time.

In the embodiments described herein, each welding power source is configured to be bound exclusively to one wireless control. However, it should be noted that in other embodiments, each wireless control may be exclusively bound to an associated welding power source, but each welding power source may be bound to multiple wireless controls via the unique address method described herein. For example, in one embodiment, the welding power source may bind to one wireless control for exclusive control over a first welding parameter and may also bind to a second wireless control for exclusive control over a second welding parameter. Indeed, in some embodiments, the welding power source may initiate multiple exclusive binds with multiple wireless controls, but each wireless control is still configured to only operate one welding power source at a time.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system, comprising:
a welding power source configured to generate a welding power output for use in a welding operation;
a wireless control device configured to substantially exclusively control operation of the welding power source when the wireless control device is bound to the welding power source; and
a receiver coupled to the welding power source and configured to dynamically determine, with the wireless control device, a first address specific to the receiver and the wireless control device pair to exclusively bind the welding power supply to the wireless control device during a learning mode.

2. The welding system of claim 1, comprising a second wireless control device, wherein the receiver is further configured to learn a second address specific to the receiver and the second wireless control device pair to exclusively bind the welding power supply to the second wireless control device during the second learning mode and to clear the second address upon initiation of a third learning mode.

3. The welding system of claim 1, comprising a second welding power source having a second receiver integrated therewith, wherein the wireless control device is further configured to learn a second address specific to the second receiver and the wireless control device pair to exclusively bind the wireless control device to the second welding power source during the learning mode and to clear the second address upon initiation of a third learning mode.

4. The welding system of claim 1, wherein the receiver is configured to lock out binding of the welding power source to the wireless control during the learning mode when the wireless control is located a distance away from the welding power source that exceeds a predefined distance.

5. The welding system of claim 1, wherein the receiver is configured to couple with the welding power source via a 14 pin connector disposed on an exterior of the welding power source.

6. The welding system of claim 1, wherein the receiver is located within the welding power source.

7. The welding system of claim 1, wherein the wireless control device is a foot activated control.

8. The welding system of claim 1, wherein the learning mode is enabled by placing the receiver and the wireless control device in their respective learning modes, and wherein the receiver is configured to enable binding of the welding power source to the wireless control during the learning mode when the wireless control is located a distance away from the welding power source that exceeds a predefined distance.

9. A method, comprising:
determining a unique address specific to a wireless control and a receiver associated with a welding power source pair;
storing the unique address in a memory of the wireless control and in a memory of the receiver of the welding power source during a learning mode, wherein when the unique address is stored in the memory of the wireless control and the memory of the receiver of the welding power source, the wireless control is configured to exclusively control operation of the welding power source; and
clearing the unique address from the memory of the wireless control and the memory of the receiver of the welding power source when a second learning mode is enabled.

10. The method of claim 9, further comprising the step of storing a second unique address in the memory of the wireless control and in a memory of a second welding power source during the second learning mode, wherein when the second unique address is stored in the memory of the wireless control and the memory of the second welding power source, the wireless control is configured to exclusively control operation of the second welding power source.

11. The method of claim 9, further comprising the step of storing a second unique address in the memory of the welding power source and in a memory of a second wireless control during the second learning mode, wherein when the second unique address is stored in the memory of the second wireless control and the memory of the welding power source, the second wireless control is configured to exclusively control operation of the welding power source.

12. The method of claim 9, wherein when the unique address is stored in the memory of the wireless control and in the memory of the welding power source, the wireless control and the welding power source are reversibly bound during an operational mode following the learning mode.

13. The method of claim 9, wherein the wireless control is one of a foot activated control and a hand activated control.

14. The method of claim 9, wherein the unique address is stored in a memory of the wireless control and in a memory of the welding power source during a learning mode only when the wireless control is located a distance from the welding power source that is less than or equal to a preset distance.

15. A welding system, comprising:
a welding power source configured to generate a welding power output for use in a welding operation;
a receiver associated with the welding power source and configured to communicate information to and from the welding power source; and
a wireless control device configured to learn a first address specific to the receiver and the wireless control device pair to exclusively bind the welding power source to the wireless control device during a learning mode when the wireless control device is located a distance from the welding power source that is below a preset threshold, wherein the wireless control device controls operation of the welding power source when the wireless control device is bound to the welding power source.

16. The welding system of claim 15, wherein the wireless control device is configured to clear the first address upon initiation of a second learning mode

17. The welding system of claim 16, wherein the wireless control device is further configured to learn a second address specific to a second receiver and the wireless control device pair to exclusively bind the second welding power source to the wireless control device during the second learning mode when the wireless control device is located a distance from a second welding power source that is below a preset threshold.

18. The welding system of claim 17, wherein the wireless control device exclusively controls operation of the second welding power source when the wireless control device is bound to the second welding power source.

19. The welding system of claim 15, wherein the wireless control device is a foot activated control device.

20. The welding system of claim 15, wherein the receiver is configured to removably couple to the welding power source via a 14 pin connection disposed on an exterior of the welding power source.

21. The welding system of claim 15, wherein the receiver is integrated with the internal circuitry of the welding power source and is located within the welding power source.
